(19) United States
(12) Patent Application Publication
(10) Pub. No.: US 2017/0148003 A1
(43) Pub. Date: May 25, 2017

(54) Systems and Methods for Generating Donations, at Point of Sale Terminals, in Connection With Purchase Transactions by Consumers

(71) Applicant: MASTERCARD INTERNATIONAL INCORPORATED, Purchase, NY (US)

(72) Inventors: Andres Lopez, New York, NY (US); Maria Fondeur Butler, New York, NY (US); Birce Arslan, Boston, MA (US); Tyler Welsh, San Diego, CA (US); Stephen Parento, White Plains, NY (US)

(21) Appl. No.: 14/947,885

(22) Filed: Nov. 20, 2015

(51) Int. Cl. G06Q 20/20; G06Q 30/02; G06Q 20/40

(52) U.S. Cl. CPC G06Q 20/20; G06Q 20/405; G06Q 30/0279

(57) ABSTRACT

Exemplary systems and methods for generating donations to charities based on transactions to payment accounts are disclosed. One exemplary method includes receiving a user preference from a consumer where the user preference relates to a donation by the consumer, to a charity, from a payment account associated with the consumer; receiving an authorization request for a purchase transaction to the payment account where the authorization request includes a donation indicator based on an input at a POS terminal associated with the purchase transaction; generating, by a computing device, a donation transaction from the payment account to a charity account associated with the charity, based on the donation indicator and the user preference; and causing a donation amount associated with the donation transaction to be funded to the charity account from the payment account.

### FIELD

The present disclosure generally relates to systems and methods for generating donations in connection with purchase transactions by consumers at merchants. More particularly, the present disclosure relates to systems and methods for generating donations at point of sale (POS) terminals, in connection with purchase transactions by the consumers, to one or more charities based on predefined preferences set by the consumers for funding the donations.

### BACKGROUND

This section provides background information related to the present disclosure which is not necessarily prior art.

Donations to charities are known. The donations are often provided by donors to the charities in the form of cash, checks, payment account transactions, etc. In addition, the donations may be provided by the donors, to the charities, as one-time donations or as repeat donations, or even as scheduled donations, depending on the donors.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in generating donations to charities, from consumers, in connection with purchase transactions by the consumers, where the donations are based on predefined consumer preferences;

FIG. 2 is a block diagram of a computing device that may be used in the exemplary system of FIG. 1; and

FIG. 3 is an exemplary method, suitable for use with the system of FIG. 1, for generating a donation to a charity, from a consumer, based on a purchase transaction by the consumer to a payment account associated with the consumer.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Charities often encourage consumers (broadly, donors herein) to make donations. In connection with the donations, the consumers may be permitted to create automatic debits or other transactions for set amounts at regular intervals, for example, weekly intervals, etc., to the charities. The systems and methods herein permit the consumers to provide preferences for the donations, including preferences related to amounts and/or designated charities for the donations, and to uniquely associate the preferences with their payment accounts. Then, when the consumers perform purchase transactions, using their payment accounts, the consumers are given options at point of sale (POS) devices processing the transactions, in some examples, to cause the donations to be made in tandem with the purchase transactions, consistent with the consumers' preferences. Or, in other examples, the donations are made automatically in tandem with the purchase transactions, consistent with the consumers' preferences. In both cases, the donations may be separate transactions to the consumers' payment accounts, or they may be incorporated into the purchase transactions. Once made, the donations are provided to accounts associated with the charities designated by the consumers.

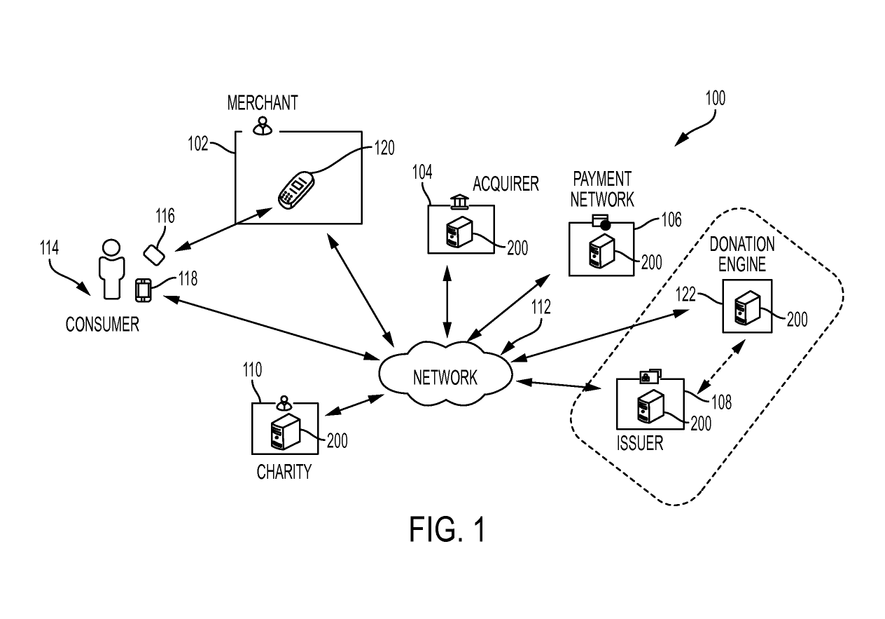

With reference now to the drawings, FIG. 1 illustrates an exemplary system 100 for use in generating donations to charities, in which the one or more aspect of the present disclosure may be implemented. Although, in the described embodiment, parts of the system 100 are presented in one arrangement, other embodiments may include the same or different parts arranged otherwise depending, for example, on authorization processes for purchase transactions involving payment accounts, designations of charities and/or preferences for consumers, processes by which charities receive donations, participation of other charities, etc.

As shown in FIG. 1, the system 100 generally includes a merchant 102, an acquirer 104, a payment network 106, an issuer 108, and a charity 110, each coupled to network 112. The network 112 may include, without limitation, a local area network (LAN), a wide area network (WAN) (e.g., the Internet, etc.), a mobile network, and/or another suitable public and/or private network capable of supporting communication among two or more of the components illustrated in FIG. 1, or any combination thereof. For example, network 112 may include multiple different networks, such as a transaction network made accessible by the payment network 106 and/or the Internet. In this example, the acquirer 104, the payment network 106, and the issuer 108 may be connected via a private transaction network (that is part of network 112) for processing purchase transactions, and the charity 110 and consumer 114 may be connected through a public network, such as the Internet (that is also part of network 112).

The charity 110 can include any organization or group (or any multiple organizations or groups), to which consumer 114 may donate funds. Without limitation, the charity 110 may be associated with a specific religion, various political groups, one or more beneficiaries, or any other category of person or entity to which the consumer 114 may donate funds. While only one charity 110 is illustrated in FIG. 1, it should be appreciated that various other charities may be included in the system 100 or in other system embodiments, and selected, as described below, by the consumer 114 (or by other consumers) to receive donations.

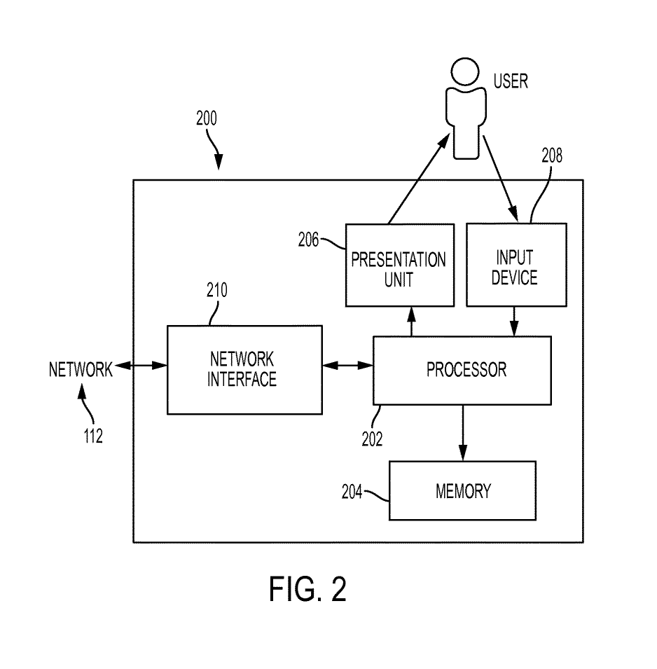

FIG. 2 illustrates an exemplary computing device 200 that can be used in the system 100. The computing device 200 may include, for example, one or more servers, workstations, personal computers, laptops, tablets, cellular phones, smartphones, POS terminals, other suitable computing devices, combinations thereof, etc. In addition, the computing device 200 may include a single computing device, or it may include multiple computing devices located in close proximity, or multiple computing devices distributed over a geographic region, so long as the computing devices are specifically configured to function as described herein. Additionally, each computing device 200 may be coupled to a network (e.g., the Internet, an intranet, a private or public LAN, WAN, mobile network, telecommunication networks, combinations thereof, or other suitable network, etc.) that is either part of the network 112, or separate therefrom.

In the system 100, each of the acquirer 104, the payment network 106, the issuer 108, and the charity 110 are illustrated as including, or being implemented in or associated with, computing device 200. Also in the system 100, consumer 114 is illustrated as including communication device 118 and the merchant 102 is illustrated as including POS terminal 120, each coupled to network 112. Both the communication device 118 and the POS terminal 120 are consistent with computing device 200. However, the system 100 and its components should not be considered to be limited to the computing device 200, as different computing devices and/or arrangements of computing devices may be used. In addition, different components and/or arrangements of components may be used in other computing devices.

As shown in FIG. 2, the illustrated computing device 200 includes a processor 202 and a memory 204 that is coupled to the processor 202. The processor 202 may include, without limitation, one or more processing units (e.g., in a multi-core configuration, etc.), including a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, tapes, hard disks, and/or any other type of volatile or nonvolatile physical or tangible computer-readable media. The memory 204 may be configured to store, without limitation, user preferences for donations, consumer registrations, charity identifiers, consumer accounts, charity accounts, transaction data, and/or other types of data suitable for use as described herein, etc. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable storage media. It should be appreciated that the memory 204 may include a variety of different memories, each implemented in one or more of the functions or processes described herein.

In the exemplary embodiment, the computing device 200 also includes a presentation unit 206 that is coupled to the processor 202. The presentation unit 206 outputs, or presents, to a user of the computing device 200 (e.g., consumer 114 in system 100, individuals associated with the charity 110 in system 100, etc.) by, for example, displaying, audibilizing, and/or otherwise outputting information such as, but not limited to, transaction data, user preferences, charity data, and/or any other type of data. It should be further appreciated that, in some embodiments, the presentation unit 206 comprises a display device such that various interfaces (e.g., applications, webpages, etc.) may be displayed at computing device 200, and in particular at the display device, to display such information and data, etc. And in some examples, the computing device 200 may cause the interfaces to be displayed at a display device of another computing device, including, for example, a server hosting a website having multiple webpages, etc. Presentation unit 206 may include, without limitation, a liquid crystal display (LCD), a light-emitting diode (LED) display, an organic LED (OLED) display, an “electronic ink” display, speakers, combinations thereof, etc. In some embodiments, presentation unit 206 includes multiple units.

The computing device 200 further includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, behaves as both presentation unit 206 and input device 208. In at least one exemplary embodiment, the presentation unit and input device are omitted.

In addition, the illustrated computing device 200 includes a network interface 210 coupled to the processor 202 (and, in some embodiments, to the memory 204 as well). The network interface 210 may include, without limitation, a wired network adapter, a wireless network adapter, a telecommunications adapter, or other device capable of communicating to one or more different networks, including the network 112. In some exemplary embodiments, the computing device 200 includes the processor 202 and one or more network interfaces incorporated into or with the processor 202.

Referring again to FIG. 1, the consumer 114 in the system 100 is associated with payment device 116. The payment device 116 may include any suitable payment device such as, for example, a credit card, a debit card, a pre-paid card, a payment token, a payment tag, a pass, another device used to provide an account number (e.g., a mobile phone, a tablet, etc.), etc. The payment device 116 is associated with a payment account, which is specific to the consumer 114, and by which the consumer 114 may fund purchase transactions for products such as goods and/or services, for example, at merchant 102. The payment account may include any suitable account including, for example, a credit account, a debit account, a prepaid account, etc. In addition in FIG. 1, the consumer 114 is associated with the communication device 118, which is illustrated as a smartphone or tablet and which may be used, in some embodiments, to provide the consumer's account number to the merchant 102.

Generally in the system 100, the merchant 102, the acquirer 104, the payment network 106, and the issuer 108 cooperate, in response to a request from the consumer 114, to complete a purchase transaction for a product using the consumer's payment account. As part of the transaction, the consumer 114 initially provides information about the payment account to the merchant 102 (e.g., a payment account number, etc.) via the payment device 116 or the communication device 118.

In a credit transaction using the payment device 116, for example, the merchant 102, at POS terminal 120, generally reads the payment account information from the consumer's payment device 116 and communicates, via the network 112, an account number (for the consumer's payment account) and the amount of the purchase (broadly, transaction data) to the acquirer 104 (as part of an authorization request) to determine whether the consumer's payment account is in good standing and whether there is sufficient credit/funds to complete the transaction. The acquirer 104, in turn, communicates with the issuer 108, through the payment network 106, for authorization to complete the transaction (e.g., using the MasterCard® interchange, etc.). If the issuer 108 accepts the transaction, an authorization is provided back to the merchant 102 and the merchant 102 completes the transaction. The credit line or funds of the consumer 114, depending on the type of payment account, is then decreased by the amount of the purchase, and the charge is posted to the account associated with the payment device 116. The transaction is later cleared and settled by and between the merchant 102 and the acquirer 104 (in accordance with a settlement arrangement, etc.), and by and between the acquirer 104 and the issuer 108 (in accordance with another settlement arrangement, etc.). Debit and pre-paid transactions are substantially similar to the above, but may further include the use of a personal identification number (PIN) authorization and more rapid posting of the charge to the account associated with the corresponding payment device, etc.

Transaction data is generated, collected, and stored as part of the above interactions among the merchant 102, the acquirer 104, the payment network 106, the issuer 108, and the consumer 114. The transaction data represents at least a plurality of transactions, e.g., completed transactions, attempted transactions, etc. The transaction data, in this exemplary embodiment, is stored at least by the payment network 106 (e.g., in a data structure associated with memory 204 of the computing device 200 of the payment network 106, etc.). Additionally, or alternatively, the merchant 102, the acquirer 104, and/or the issuer 108 may store the transaction data, or part thereof, in a data structure. Or transaction data may be transmitted between entities of system 100, as used or needed. The transaction data may include, for example, payment account numbers, merchant IDs (specific to the POS terminal 120 within the merchant 102, for example), merchant addresses, amounts of transactions, merchant category codes, dates/times of transactions, indicators of products purchased and related descriptions or identifiers, etc. It should be appreciated that more or less information related to transactions, as part of either authorization and/or clearing and/or settling, may be included in transaction data and stored within the system 100, at the merchant 102, the acquirer 104, the payment network 106, and/or the issuer 108. Further, transaction data, unrelated to a particular payment account, may be collected by a variety of techniques, and similarly stored within the system 100.

In various exemplary embodiments, consumers involved in the different transactions herein are prompted agree to legal terms associated with their payment accounts, for example, during enrollment in their accounts, etc. In so doing, the consumers may voluntarily agree, for example, to allow merchants, issuers of the payment accounts, payment networks, etc., to use data collected during enrollment and/or collected in connection with processing the transactions, subsequently for one or more of the different purposes described herein.

With continued reference to FIG. 1, the system 100 further includes a donation engine 122 illustrated as including, or being implemented in or associated with, computing device 200. The donation engine is specifically configured, often by executable instructions, to cause processor 202 of the computing device 200, for example, to perform one or more of the different operations described herein. While the engine 122 is illustrated as a standalone part of the system 100, it may be incorporated in (or associated with) the issuer 108 (as indicated by the dotted lines in FIG. 1) or in (or with) other parts of the system 100 (e.g., the payment network 106, etc.) or in (or with) other parts of other systems.

As will be described, through the donation engine 122, the system 100 offers various services or opportunities, by which the consumer 114 is permitted to make donations to the charity 110 (and/or to other charities) as part of purchase transactions to merchant 102 or to other merchants using the consumer's payment device 116.

For example, the consumer 114 may initially register to the donation engine 122, whereby the consumer 114 creates a profile (e.g., a user profile, etc.) linked to the consumer's payment account (and, thus, to the consumer's payment device 116). The registration is provided through one or more web-based interfaces (e.g., websites, applications, etc.), which are accessible to the consumer 114 (via the communication device 118, for example) either directly or, in some embodiments, via an application programming interface (API) or other link from one or more web-based interfaces associated with the issuer 108 (or other part of the system 100). Alternatively, when or if the donation engine 122 is associated with and/or incorporated in the payment network 106, the profile may be created by the consumer 114 through interaction with one or more web-based interfaces associated with the issuer 108, which calls an API associated with the payment network 106. As can be appreciated, various options may be available to the consumer 114 to set up donations from his/her payment account, in connection with the aspects of the present disclosure.

The profile created during the registration (and, more broadly, generated by the donation engine 122 in response to the inputs provided by the consumer 114) is stored, for example, in memory 204 of the computing device 200 (associated with the donation engine 122). As part of creating the profile, the consumer 114 provides one or more preferences (i.e., user preferences) relating to the donations to be made as part of purchase transactions to the consumer's payment account and, from which, the donation engine 122 is then able to cause donations to charities, for example, charity 110, consistent with the consumer's preferences. The preferences, once set, are then associated with, or stored with, the profile for the consumer 114 in the memory 204. As such, the preferences can be readily retrieved by the donation engine 122, upon detection of a purchase transaction involving the consumer 114.

In various aspects, once the profile for the consumer 114 is created and the one or more charities are identified, as user preferences, the donation engine 122 communicates with the charity 110, for example, to verify the information about the charity 110 provided by or from the consumer 114. More specifically, the donation engine 122 confirms the charity 110, and the charity account for the charity 110 into which the donations are to be funded and/or deposited. In this manner, the charity 110 can be linked by the consumer 114 for subsequent donations consistent with the description herein. In so doing, not only is the consumer 114 able to provide donations to the charity 110 through the system 100, but the charity 110 is more generally set up and/or available within the system 100, whereby one or more other consumers can then provide donations through the system 100 to the charity 110, for example, upon identification or selection of the charity 110, etc.

Further, the preferences provided by the consumer 114 in the profile, during registration, may include any suitable preferences. In addition, any number of preferences may be provided by, or be made available to, the consumer 114 through the donation engine 122 to define donations and/or to alter donations based on, for example, timing of the donations, frequency of the donations, total numbers of the donations, donation amounts per transaction, particular merchants or categories of merchants (e.g., based on merchant category code, etc.) at which transactions should qualify for the donations, etc.

As an example, a preference provided by the consumer 114 may include a specified donation amount to be made per transaction. In connection therewith, the user may set the donation amount to include a static amount per transaction, such as $0.50 per transaction. Or, the user may set the donation amount based on the purchase amount of the transaction, such as $0.10 per every $10.00 purchase amount, or 1% per every $1.00 purchase amount. As another example, a preference may include a designation of a particular charity, or of multiple particular charities, to receive donations from the consumer 114, such that the donations are provided to the particular charity (or charities) as compared to other charities. As still another example, a preference may include an instruction to make donations transaction specific. Here, the consumer 114 may specify that donations for purchases at grocery stores be made to a food bank charity, while donations for purchases at pet stores be made to an animal shelter charity. As a further example, a preference may include an instruction to make different donation amounts for purchases at different merchants, or for purchases at merchants in different categories (e.g., for merchants having different merchant category codes, etc.). As another example, a preference may include a limitation on a number of donations to be made and/or on a donation amount to be made such as, for example, not more than $25.00 per month in total donations, or no more than 10 donations per month, etc. Such limitations may further be specified for particular merchants, or merchants in particular categories, as desired.

In various embodiments, donation amounts, timing, and/or other aspects of donation transactions, as generated by the donation engine 122, may further be modified or limited by conditions set by the acquirer 104, by the charity 110, by the payment network 106, and/or by the issuer 108. For example, the issuer 108 or the payment network 106 may match donations made by the consumer 114, or donations associated with purchase transactions at particular merchants (or categories of merchants), up to a specific amount (e.g., a specific amount per transaction, a specific amount per time period, etc.).

In operation in the system 100, when the donation engine 122 detects an authorization request for a purchase transaction to the payment account associated with the consumer 114, the donation engine 122 determines, based on the consumer's preferences (and any other imposed limitations), if a donation transaction should be made, for example, to charity 110 (when set as a designated charity preference by the consumer 114). In some purchase transactions, the donation engine 122 automatically causes the donation transaction when the applicable preferences are satisfied. In other purchase transactions, the donation engine 122 only causes the donation transaction upon receipt of a specific instruction to cause the donation transaction (e.g., when such requirement is set as a preference by the consumer 114, etc.), and when the other applicable preferences are also satisfied. In the system 100, for example, the specific instruction may include an input from the consumer 114 at the POS terminal 120 of the merchant 102 (e.g., a “Yes” or “No” donation confirmation, etc.), in connection with a purchase transaction by the consumer 114 at the merchant 102 (however, other inputs may be provided in other embodiments). The input is then indicated in the authorization request transmitted from the merchant 102 to the issuer 108.

After the donation transaction is generated, or appended to the consumer's purchase transaction as part of the detected authorization request, the donation engine 122 causes the clearing and settlement processes for the purchase transaction to also include funding the charity account associated with the charity 110, for example, in the amount of the specified donation, or in the amount(s) of multiple donations. This may be done on a per transaction basis, or it may be done on a batch basis (e.g., once a particular number of donation transactions have been generated for the consumer 114 or in general for a group of consumers, etc.). The donation engine 122 then interacts with the issuer 108 to report donation summaries, details etc. for the consumer 114. The issuer 108, in turn, incorporates the summaries, details, etc. into one or more billing statements associated with the consumer's payment account. The statements (or separate statements therefrom) may include particular donation transactions, total donation amounts, etc. funded by the consumer's payment account (by charity, by category, etc.), for a time period (e.g., a month, a quarter, a year, etc.).

While only one merchant 102, one acquirer 104, one payment network 106, one issuer 108, and one consumer 114 are illustrated in FIG. 1 (for ease of reference), it should be appreciated that a variety of other embodiments may include multiple ones of these parts in various combinations.

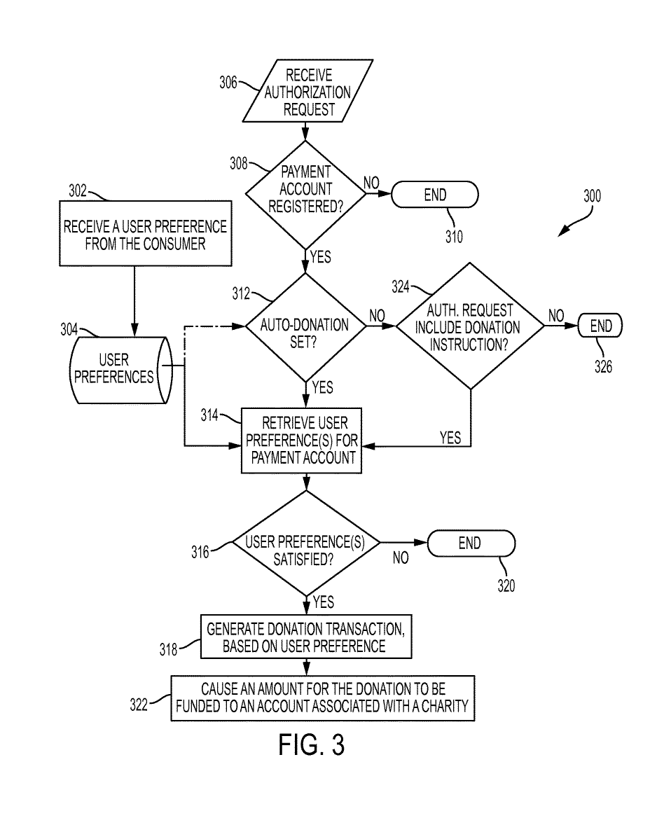

FIG. 3 illustrates an exemplary method 300 of generating a donation to a charity in connection with a purchase transaction by a consumer at a merchant using a POS terminal associated with the merchant. The exemplary method 300 is described herein in connection with the system 100, and may be implemented in the donation engine 122 of the system 100. Further, for purposes of illustration, the exemplary method 300 is also described with reference to computing device 200. However, it should be appreciated that the method 300, or other methods described herein, are not limited to the system 100, or computing device 200. And, conversely, the systems and computing devices described herein are not limited to the exemplary method 300.

Initially in the method 300, the consumer 114 registers to the donation engine 122 (as described above in connection with the system 100), whereby the consumer 114 creates a profile linked to the consumer's payment account (and the consumer's payment device 116). As part of the registration, or later, the consumer 114 provides various preferences (as also described above in connection with system 100), or modifies current preferences, relating to donations to be made as part of purchase transactions to the consumer's payment account, for example, that all donations will be made to charity 110, etc. In response, the donation engine 122 receives the preferences, at 302 in the method 300, and associates them with the profile for the consumer 114. The profile and the preferences (and any subsequent modifications to the preferences) are stored in a data structure 304 by the donation engine 122, in memory 204, for example, of the donation engine's computing device 200.

Separately, when the consumer 114 desires to purchase a product at the merchant 102, the consumer 114 presents the payment device 116 to the merchant 102 and, in particular in this embodiment, to the POS terminal 120 associated with the merchant 102 in order to complete a purchase transaction for the product. Upon receiving/reading the payment device 116, the POS terminal 120 may prompt the consumer 114 to append a donation, for example, to charity 110, to the purchase transaction (e.g., consistent with the preferences previously set by the consumer 114, etc.). Such prompt may be provided to all consumers using the POS terminal 120, or only to consumer's that are registered to the donation engine 122 (e.g., the POS terminal 120 may transmit a communication to the donation engine 122 to determine if a consumer is registered, etc.). The prompt may simply include an option to select “Yes” or “No,” to either confirm or decline adding a donation to the purchase transaction. Or, in other embodiments, the prompt may be more complex and may include a particular request for the consumer 114 to provide a charity name or charity designation for the charity 110 and an amount for the donation, etc. (although this additional level of complexity is not required). Further, in some embodiments, such a prompt may not be used at all at the POS terminal 120, and any donation based on the purchase transaction will be subsequently determined by the donation engine 122 based on the consumer's preferences in his/her profile (i.e., a donation will automatically be made in connection with the purchase transaction if appropriate based on the consumer's preferences).

In response to the purchase transaction by the consumer 114, the POS terminal 120 generates an authorization request for the purchase transaction, as described above for the purchase transaction in system 100. In addition, if the consumer 114 provided an input to the POS terminal 120 to append a donation to the purchase transaction (although such an input is not required in all embodiments), the POS terminal 120 also includes a donation instruction in the authorization request (e.g., as part of the transaction data, etc.). The donation instruction may simply include a “Yes” or “No” indicating whether or not a donation is to be made consistent with the consumer's preferences, or it may include specific instructions (although such specific instructions are not required) for the donation as provided by the consumer 114 at the POS terminal 120, or potentially gleaned from the consumer's profile, from data structure 304.

In turn, at 306 in the method 300, the donation engine 122 detects and/or receives the authorization request for the purchase transaction, from the POS terminal 120 (e.g., as it is communicated from the POS terminal 120 to the acquirer 104, to the payment network 106, or to the issuer 108, etc.). From transaction data in the authorization request, the donation engine 122 identifies the payment account involved in the purchase transaction and, at 308, determines (or confirms, if a donation instruction is already included in the authorization request, although again such an instruction is not required in the authorization request in all embodiments) if (or that) the consumer's payment account is registered to make donations (e.g., to charity 110, etc.). If the consumer's payment account is not registered, the donation engine 122 terminates the method 300, at 310, and the authorization request is processed in typical fashion as described above.

However, if the consumer's payment account is registered to make donations, the donation engine 122 determines, at 312, if the consumer's profile includes an auto-donation preference. For example, the donation engine 122 may access the consumer's profile, in data structure 304 and/or retrieve data/information therefrom (as indicated by the dotted lines in FIG. 3), to determine if the auto-donation preference is present. The auto-donation preference instructs the donation engine 122 to generate a donation transaction to the charity 110, regardless of whether the consumer 114 provided an input to the POS terminal 120 during the purchase transaction requesting a donation or not (and regardless of whether such an input was even available at the POS terminal 120).

When the auto-donation preference is present in the consumer's profile, the donation engine 122 then retrieves, at 314, from the data structure 304, all applicable preferences for the payment account in the consumer's profile relating to the purchase transaction. This may include a preference that the donation be made to charity 110, a preference for an amount of the donation, a preference that limits the donation if total donations for the consumer's payment account already exceed (or will exceed if the current donation is made) predefined amounts or quantities, etc. As an example, the consumer's preferences may indicate that a donation of $0.50 is to be made to the charity 110, based on the purchase transaction (and based on all purchase transactions), as long as total donations to the charity 110 for the current month have not exceeded $25.00 and as long as the merchant 102 at which the purchase transaction took place is a grocery store (e.g., as determined based on merchant category code for the merchant 102, etc.).

Next, if the donation engine 122 determines that all of the consumer's applicable preferences for the purchase transaction are satisfied (for user preferences that define conditions for donations), at 316, the donation engine 122 generates a donation transaction, at 318. The donation transaction is again based on the consumer's preferences (which again may be accessed from the data structure 304 as necessary), and is directed toward an account associated with the charity 110. For example, if the consumer's preferences indicate that a donation of $0.50 is to be made to the charity 110, based on the purchase transaction, the donation engine 122 generates the donation transaction in an amount of $0.50 payable to the charity 110 from the consumer's payment account. It should be appreciated that certain preferences may be relevant to different operations in the method 300. For example, at 316 the donation engine 122 may cause or not cause a donation transaction based on a preference related to a maximum donation per month, but instead may rely on a different user preference related to a particular charity or amount in generating the donation transaction (if conditional preferences set by the consumer 114 so indicate).

However, if the consumer's applicable preferences are not satisfied at 316, the donation engine terminates the method 300, at 320, and the authorization request is processed for the purchase transaction in typical fashion as described above.

In connection with the donation transaction, when generated at 318, the donation engine 122 appends the corresponding data associated with the donation transaction to the authorization request (e.g., the donation amount, the name of the charity 110, account details for the charity 110, etc.). In so doing, the specified amount of the donation may be added directly to (or summed with) the amount of the purchase transaction (so that the authorization request includes a single transaction amount comprising the purchase amount and the donation amount), or it may be included as a separate donation entry in the authorization request. In either case, the donation transaction is then generally synonymous with the purchase transaction in the authorization request and is processed in accordance therewith. Alternatively, in some embodiments, the donation transaction may be processed as a separate transaction (and in a separate authorization request), for example, from the merchant 102 and through the acquirer 104, the payment network 106, and/or the issuer 108 (as described above).

For the purchase transaction in this embodiment involving the POS terminal 120, once the donation transaction is appended to the authorization request (either summed with the amount of the purchase transaction or as a separate donation entry), the donation engine 122 communicates the authorization request back to the POS terminal 120. The POS terminal 120 then communicates the modified authorization request, via the network 112, to the acquirer 104, the payment network 106, and the issuer 108 (as described above). Alternatively, in some embodiments, the donation engine 122 may communicate the modified authorization request directly to the acquirer 104. In either case, once the request is authorized by the issuer 108 (for the combined purchase amount and donation amount), the purchase portion/amount of the transaction is cleared and settled as described above. And, the donation portion/amount of the transaction is cleared by and between the merchant 102, the acquirer 104, the issuer 108, the charity 110, and the donation engine 122 (e.g., in response to a clearing request generated by either the charity 110, or the payment network 106 (or alternatively by the issuer 108 or the donation engine 122) on behalf of the charity 110; etc.). The donation amount is then funded to the account associated with the charity 110, at 322, via a normal settlement processes.

With continued reference to FIG. 3, if an auto-donation preference is not present in the consumer's profile, at 312, the donation engine instead determines, at 324, if the authorization request includes a donation instruction from the consumer 114 (as input by the consumer 114 to the POS terminal 120 during the purchase transaction). When such an instruction is present, the donation engine 122 retrieves, at 314, as described above, all applicable preferences for the payment account in the consumer's profile relating to the purchase transaction. However, if no such instruction is present, the donation engine 122 terminates the method 300, at 326, and the authorization request is processed for the purchase transaction in typical fashion as described above.

As the donation transactions are completed in the method 300, and prior, the donation engine 122 may store donation values, donation transactions, and other information related to the above, in memory 204 of computing device 200. The information may be accessible to the charity 110, or through the charity's website (or through a related application) to permit the charity 110 to view and/or disseminate certain information about donations received, or to permit the consumer 114 to review transactions and donation details for the charity 110 and/or the consumer's associated payment account (e.g., statements indicating total donations for given time periods, etc.). In various embodiments, a dashboard may be viewable by the charity 110 (e.g., hosted by the charity 110 or by the donation engine 122, etc.), which provides summaries of, for example, donations per time period, total registered consumers/donors, total donation values, total donation transactions, average donations per consumer, etc. Similarly, in various embodiments, a dashboard may be available to the consumer 114, through a charity's website, whereby the consumer 114 is able to view, for example, depictions of historical donations, transactions, goals and/or predicted donations, and/or reports related to declined transactions, donations, transactions, goals, etc.

In other embodiments, when a purchase transaction by the consumer 114 does not involve a POS terminal (e.g., when the purchase transaction is an online transaction, etc.), a donation transaction may still be generated by the donation engine 122 and appended to an authorization request for the purchase transaction (e.g., consistent with operations 304-318 of method 300, etc.). In these embodiments, however, it is contemplated that the donation engine 122 may receive the authorization request from either the merchant 102 or the acquirer 104, and may then communicate the authorization request, as modified to include a donation transaction if applicable, directly to the acquirer 104 which then communicates with the payment network 106 and the issuer 108 (as described above). Once the modified authorization request is authorized by the issuer 108 (for the combined purchase amount and donation amount), the purchase portion of the transaction is cleared and settled as described above. And, the donation portion of the transaction is cleared by and between the merchant 102, the acquirer 104, the issuer 108, the charity 110, and the donation engine 122 (e.g., in response to a clearing request generated by the charity 110, or by either the payment network 106 or issuer 108 on behalf of the charity 110, etc.). The donation amount is then funded to the account associated with the charity 110, at 318, via a normal settlement processes. It addition in these embodiments, the consumer 114 may still be given an option (at one or more interfaces associated with the merchant 102 and/or the consumer's communication device 118) to append a donation to the purchase transaction (although such an option is not required in all of the embodiments), and a donation instruction may then be included in the authorization request (e.g., as part of the transaction data, etc.).

It should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a user preference from a consumer, the user preference relating to a donation by the consumer, to a charity, from a payment account associated with the consumer; (b) receiving an authorization request for a purchase transaction to the payment account, the authorization request including a donation indicator based on an input at a POS terminal associated with the purchase transaction; (c) generating a donation transaction from the payment account to a charity account associated with the charity, based on the donation indicator and the user preference; (d) causing a donation amount associated with the donation transaction to be funded to the charity account from the payment account; and (e) causing a statement associated with the payment account to include a total donation amount for a time period.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for use in generating donations to charities through transactions to payment accounts, the system comprising:
a memory comprising user profiles for multiple consumers, the user profiles including preferences relating to donations to charities by the consumers from payment accounts associated with the consumers, the preferences including at least charity accounts for the charities and donation amounts to be funded to the charity accounts when certain preferences relating to the charities are satisfied; and
an engine coupled to the memory and configured, for each purchase transaction performed by the consumers having the user profiles in the memory, to:
modify an authorization request for the purchase transaction to the consumer's payment account to include a donation transaction, based on at least one of the preferences in the consumer's user profile, whereby the purchase transaction and the donation transaction form a common transaction in the authorization request; and
cause a donation amount associated with the donation transaction, as indicated in the memory, to be funded to a charity account from the consumer's payment account.

2. The system of claim 1, wherein the engine is further configured, for each purchase transaction performed by the consumers having the user profiles in the memory, to add the donation amount associated with the donation transaction to a purchase amount associated with the purchase transaction in the authorization request.

3. The system of claim 2, wherein the engine is further configured, for each purchase transaction performed by the consumers having the user profiles in the memory, to:
receive the authorization request from a point of sale (POS) terminal associated with a merchant; and
after the authorization request is modified, transmit the authorization request back to the POS terminal.

4. The system of claim 2, wherein the engine is further configured, for each of the payment accounts associated with the user profiles in the memory, to generate a statement associated with the payment account to include a total donation amount funded from the payment account for a time period.

5. A computer-implemented method for use in generating a donation to a charity through a transaction to a payment account, the method comprising:
receiving a user preference from a consumer, the user preference relating to a donation by the consumer, to a charity, from a payment account associated with the consumer;
receiving an authorization request for a purchase transaction to the payment account associated with the consumer, the authorization request including a donation indicator based on an input at a point of sale (POS) terminal associated with the purchase transaction;
generating, by a computing device, a donation transaction from the payment account to a charity account associated with the charity, based on the donation indicator and the user preference; and
causing a donation amount associated with the donation transaction to be funded to the charity account from the payment account.

6. The computer-implemented method of claim 5, wherein the user preference identifies at least the donation amount.

7. The computer-implemented method of claim 6, wherein generating a donation transaction from the payment account based on the donation indicator and the user preference further includes generating the donation transaction only when at least one different user preference is satisfied.

8. The computer-implemented method of claim 7, wherein the at least one different user preference includes a category of merchant; and
wherein generating the donation transaction includes generating the donation transaction when the authorization request is received from a merchant within said category and based on the donation indicator and the user preference.

9. The computer-implemented method of claim 5, wherein the user preference specifies a first charity when the authorization request is received from a merchant within a first category; and
wherein the user preference specifies a second charity when the authorization request is received from a merchant within a second category, the first and second charities being different.

10. The computer-implemented method of claim 5, wherein generating the donation transaction includes modifying the authorization request to include the donation transaction, whereby the purchase transaction and the donation transaction form a common transaction.

11. The computer-implemented method of claim 10, wherein modifying the authorization request includes adding the donation amount associated with the donation transaction to a purchase amount associated with the purchase transaction.

12. The computer-implemented method of claim 11, wherein modifying the authorization request further includes identifying the charity and the charity account in the authorization request.

13. The computer-implemented method of claim 10, wherein receiving an authorization request includes receiving the authorization request at the computing device from the POS terminal; and
further comprising, after modifying the authorization request, transmitting, by the computing device, the authorization request back to the POS terminal.

14. The computer-implemented method of claim 10, wherein receiving an authorization request includes receiving the authorization request at the computing device from the POS terminal; and
further comprising, after modifying the authorization request, transmitting, by the computing device, the authorization request to an acquirer associated with the POS terminal.

15. The computer-implemented method of claim 5, further comprising causing a statement associated with the payment account to include a total donation amount for a time period.

16. A non-transitory computer-readable storage media including computer executable instructions that, when executed by at least one processor, cause the at least one processor to:
generate a user profile for a consumer, the user profile comprising one or more preferences of the consumer relating to a donation by the consumer to a charity from a payment account associated with the consumer;
modify an authorization request involving a purchase transaction to the consumer's payment account to include a donation amount to the charity indicated in the user profile for the consumer, based on the one or more preferences of the consumer in the user profile; and
cause the donation amount to be funded to a charity account associated with the charity from the consumer's payment account.

17. The non-transitory computer-readable storage media of claim 16, wherein the one or more preferences of the consumer in the user profile identify at least the donation amount.

18. The non-transitory computer-readable storage media of claim 17, further including computer executable instructions that, when executed by the at least one processor, cause the at least one processor to:
receive the authorization request from a point of sale (POS) terminal associated with a merchant; and
after the authorization request is modified to include the donation amount, transmit the authorization request back to the POS terminal.

19. The non-transitory computer-readable storage media of claim 18, further including computer executable instructions that, when executed by the at least one processor, cause the at least one processor to cause a clearing request to be transmitted for the donation amount.

20. The non-transitory computer-readable storage media of claim 18, further including computer executable instructions that, when executed by the at least one processor, cause the at least one processor to generate a statement associated with the consumer's payment account to include a total donation amount for a time period.
